(19) United States
(12) Patent Application Publication
(10) Pub. No.: US 2010/0270848 A1
(43) Pub. Date: Oct. 28, 2010

(54) APPARATUS FOR OPENING HOPPER DOOR

(76) Inventors: DALE J. HEIDER, HUMBOLDT, IA (US); LEON J. HEIDER, HUMBOLDT, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 12/429,784

(22) Filed: Apr. 24, 2009

(51) Int. Cl. B60P 1/56; F15B 15/22

(52) U.S. Cl. 298/27

(57) ABSTRACT

A hopper door opening and closing apparatus uses a pneumatic cylinder to open and close the sliding hopper door. A control valve maintains pressure on both sides of a piston within the pneumatic cylinder to provide a smooth operation of the door opening and closing process.

### FIELD OF THE INVENTION

The present invention relates generally to mechanisms for opening and closing hopper doors, and more particularly to a pneumatically actuated apparatus for opening and closing a hopper door on a grain trailer.

### BACKGROUND OF THE INVENTION

A hopper trailer is a trailer that includes one or more discharge hoppers below the trailer body. Each of the hoppers includes a discharge opening through which grain, or other loose granular material may flow in order to empty the trailer. The discharge opening at the lower end of the hopper is typically provided with a door that can be selectively opened and closed by a user to permit flow through the discharge opening or to prevent flow through the discharge opening. In a conventional design, the door slides in a generally horizontal plane to open and close the discharge opening.

One disadvantage of the conventional sliding door design is that it is difficult to move the door when the trailer is fully loaded with grain or other bulk materials. According to a conventional design a hand crank is provided to allow a user to move the sliding door back and forth between the open and closed positions. However, it can be difficult and inconvenient to manually provide the necessary force to move the sliding door.

Large hopper trailers are typically provided with air brakes, and often times a pneumatic suspension system. The air brake system must have a supply of pressurized air, typically provided by a compressor located on the towing vehicle. Additionally, the air brake system is commonly provided with a reserve reservoir of pressurized air to maintain a relatively steady pressure for the air supply to the brake system, and to act as a reserve in case the compressor is not supplying pressurized air.

U.S. Pat. No. 6,749,268 to Wheeler discloses using a pneumatic cylinder to open pendulum type-doors used to open and close discharge openings on grain trailer hoppers. However, the design of Wheeler is not suitable for use in association with the more common sliding door designs. Furthermore, the Wheeler design requires the use of a large torsion spring to maintain the doors in the closed position, in case of a loss of air pressure to the pneumatic cylinder.

Therefore, it is an object of the present invention to provide an improved pneumatic door opening and closing mechanism for use with a sliding door that opens and closes a discharge opening located at the lower end of a hopper chute.

### SUMMARY OF THE INVENTION

According to one embodiment, the present invention is directed to a grain trailer for hauling grain and for discharging grain through a downwardly disposed hopper gate. The grain trailer includes a grain trailer body that has a storage compartment. A downwardly disposed discharge opening is in flowable communication with the storage compartment. A slidable door is movable between a closed position to cover the discharge opening and an open position to permit flow of grain from the storage compartment though the discharge opening. A control valve is provided between a pneumatic cylinder and a supply of pressurized air for selectively activating the pneumatic cylinder to move the hopper door between the open and closed positions.

According to another embodiment, the present invention is directed to a hopper door assembly. The hopper door assembly includes a first rail for mounting to a discharge chute that has a downwardly disposed opening, the first rail having an inner face that generally faces towards the chute and an outer face that generally faces away from the chute. A second rail for mounting to the discharge chute opposite and parallel to the first rail has an inner face that generally faces towards the chute and an outer face that generally faces away from the chute. A slidable door is movable between a closed position that covers the discharge chute opening and an open position that permits flow through the discharge chute opening. A pneumatic cylinder is operably connected to the slidable door to selectively urge the door towards the open and closed positions. The hopper door assembly may include a second pneumatic cylinder mounted to the outer face of the second rail to selectively urge the door between the open and closed positions. The hopper door assembly may include a plurality of rollers mounted on the inner faces of the rails, and the door may be supported by the rollers.

According to another embodiment, the present invention is directed to a door opening and closing mechanism for attachment to a hopper frame of the type that has a discharge opening and a door slidably connected to the hopper frame for movement between a closed position to substantially block the opening and an open position to permit flow of particulate through the opening. The door opening and closing mechanism includes a pneumatic cylinder and piston operably connected to the door and the frame to selectively move the door between the open and closed positions. The mechanism further includes a connection to a supply of pressurized air. A valve is provided in line between the connection to the supply of pressurized air and the pneumatic cylinder. The valve has a first position to simultaneously exhaust air from the first side of the piston and supply pressurized air to a second side of the piston in order to urge the piston in the direction of the first side of the piston to open the door. The valve has a second position to simultaneously supply pressurized air on the first side of the piston and vent air on the second side of the piston in order to urge the piston towards the second side and thereby close the door. The valve has a third position that prevents air from flowing into and out of the cylinder on both sides of the piston in order to maintain the door in a steady state. A control is provided for selectively moving the valve between the first second and third positions.

### BRIEF DESCRIPTION OF THE DRAWINGS

FIG. 1 is a side elevation view of a grain trailer that includes a hopper door opening and closing apparatus according to one embodiment of the present invention.

FIG. 2 is partial perspective view of a hopper and hopper door opening and closing apparatus from the grain trailer of FIG. 1.

FIG. 3 is an isometric view of a hopper door opening and closing apparatus according to one embodiment of the present invention with the door in a closed position.

FIG. 4 is a top plain view of the hopper door opening and closing apparatus of FIG. 3.

FIG. 5 is an isometric view of the hopper door opening and closing apparatus of FIG. 3 adjusted to an open position.

FIG. 6 is a top plan view of the hopper door opening and closing apparatus of FIG. 5.

FIG. 7 is a bottom plan view of the hopper door opening and closing apparatus of FIG. 3.

FIG. 8 is schematic view of the pneumatic components of a hopper door opening and closing apparatus according to one embodiment of the present invention.

FIG. 9 is a cross sectional view of a pneumatic cylinder according to one embodiment of the present invention.

FIG. 10 is a perspective view of a control valve according to one embodiment of the present invention.

### DETAILED DESCRIPTION OF THE PREFERRED EMBODIMENT

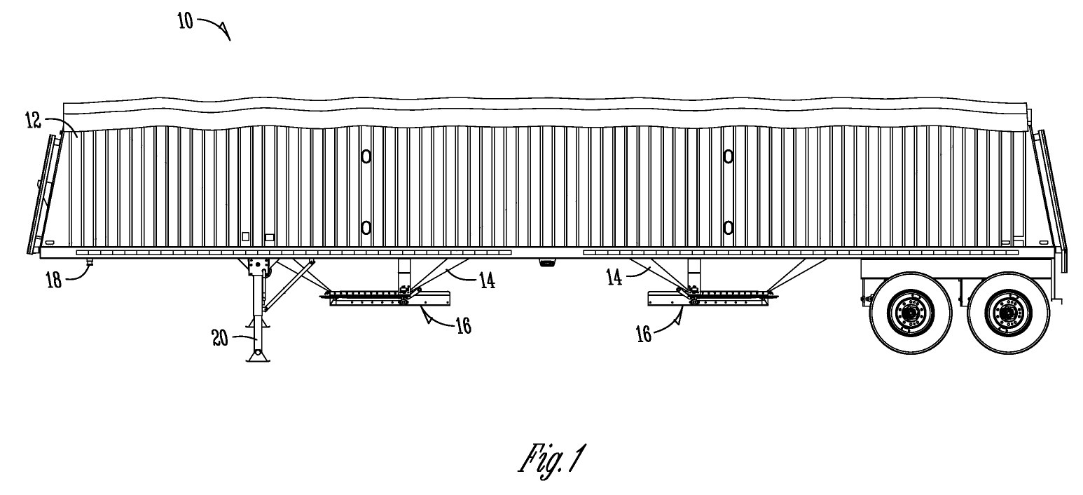

FIG. 1 shows a hopper trailer 10 according to one embodiment of the present invention. The hopper trailer 10 includes a storage compartment 12 that is suited for containing grain, coal, fertilizer, gravel, sand, or other loose solid flowable material. The lower portion of the storage compartment 12 is provided with hoppers that terminate at their lower portion with hopper chutes 14. A hopper door opening and closing apparatus 16 is provided on each of the hopper chutes 14. The hopper trailer 10 of FIG. 1 includes a kingpin structure 18 that is adapted to be connected to the fifth wheel of a truck (not shown) or other towing vehicle. Collapsible and foldable jacks 20 are provided to support the hopper trailer 10 when it is not connected to a towing vehicle.

The hopper chutes 14 act as funnels to guide the flow of granular material (not shown) within the storage compartment 12 through discharge openings (not shown) at the lower extreme of the hopper chutes 14. The hopper door opening and closing apparatus 16 provides a mechanism for controlling the flow of the granular material through the discharge openings.

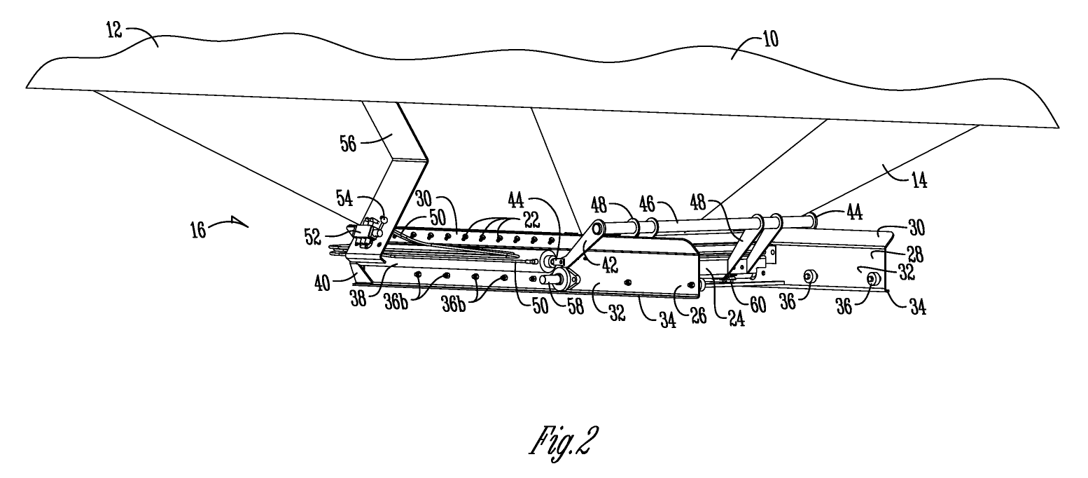

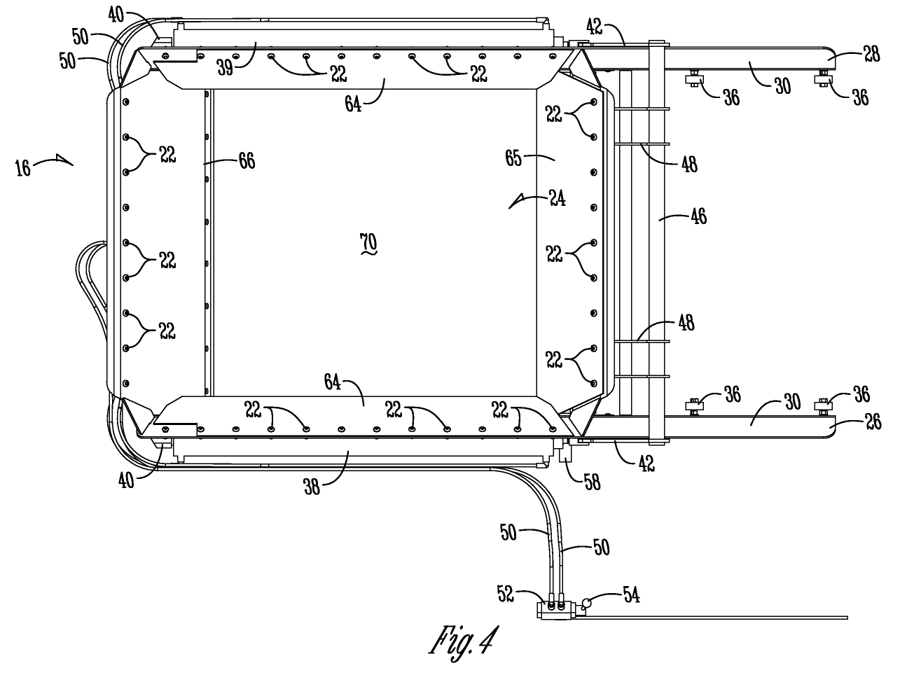

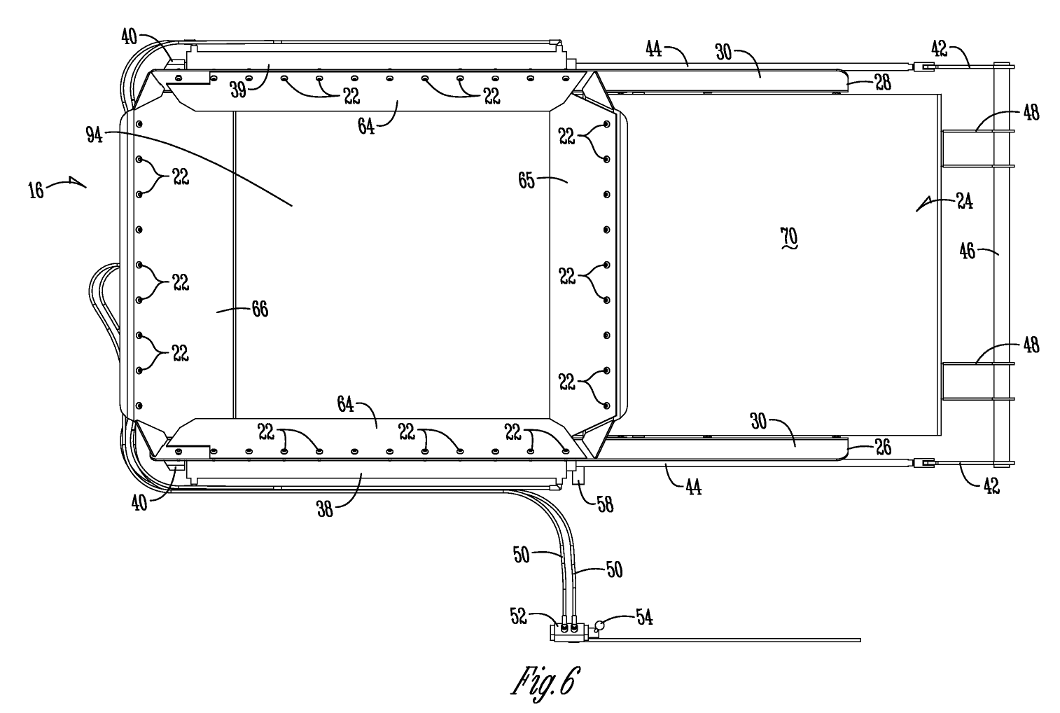

Additional details of the hopper door opening and closing apparatus 16 can be seen in FIG. 2. As seen in FIG. 2, the door opening and closing apparatus 16 is mounted at a lower end of the hopper chute 14, which extends beneath storage compartment 12 of the hopper trailer 10. The apparatus 16 includes a door 24 that is slidably mounted between a first rail 26 and a second rail 28. Each of the rails 26 and 28 includes an upper portion 30 that is contoured to match the slope of the lower portion of the hopper chute 14, a central portion 32 that is generally vertically oriented, and a lower lip 34 that provides additional strength to the rails 26 and 28. The upper portions 30 of the rails 26 and 28 are bolted to the bottom portion of hopper chute 14 with bolts 22. The inner faces of the rails 26 and 28 are provided with rollers 36 that act as bearings for the door 24. The rollers 36 may be attached to the rails 26 and 28 by bolts 36b. Other bearing structures besides rollers 36 may be used to support the door 24 in a sliding relation between the rails 26 and 28. A pneumatic cylinder 38 is mounted to the outer face of rail 26 using brace 40. A second similar pneumatic cylinder 39 (not shown in FIG. 2, see FIGS. 4 and 6) is mounted to an outer face of the second rail 28. The pneumatic cylinder 38 is operably connected to the door 24 by link member 42 that is attached to the extendable rod 44 of the cylinder 38 and to bar 46 which in turn is attached to the door 24 by a pair of connection flanges 48. Air lines 50 pneumatically connect the pneumatic cylinder 38 with control valve 52. An adjustment handle 54 permits a user to adjust the control valve 52. The control valve 52 is mounted on support 56 that extends from the trailer body 10 at a convenient height and location for easy access by a user.

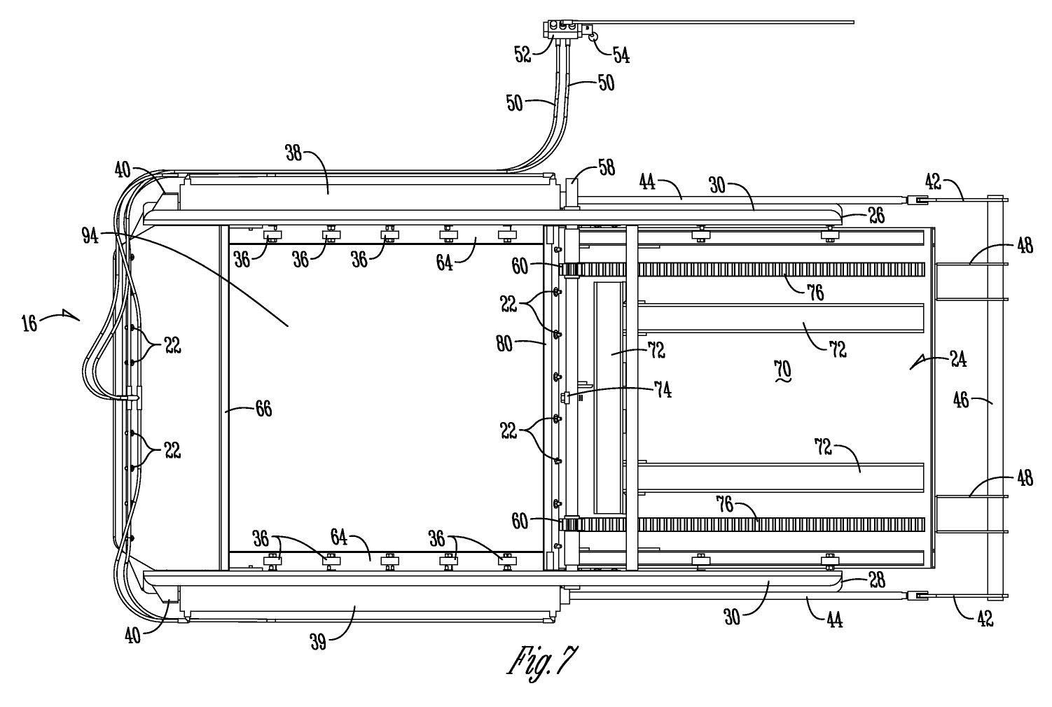

Also shown in FIG. 2 is a rotatable spindle 58 that extends outwardly from the first rail 26 for attachment to a crank handle. The spindle 58 spans between the rails 26 and 28 and has a pair of pinion gears 60 that engage a pair of corresponding racks 76 (not shown in FIG. 2, see FIG. 7) on the bottom of slidable door 24. The spindle 58 and pinion 60 may be omitted in some embodiments of the present invention. If the rack and pinion arrangement is used, it helps to maintain the door 24 in proper alignment between the rails 26 and 28. Additionally, if a crank handle is attached to spindle 58, it can be used to provide emergency or supplementary force to move the door 24 back and forth between the open and closed positions. Alternatively, the piston rod 44 could be provided with a rack, and the spindle 58 could be provided with a pinion on the exterior portion, such that the pneumatic cylinder 38 could provide the driving force for moving the door 24 by rotating spindle 58.

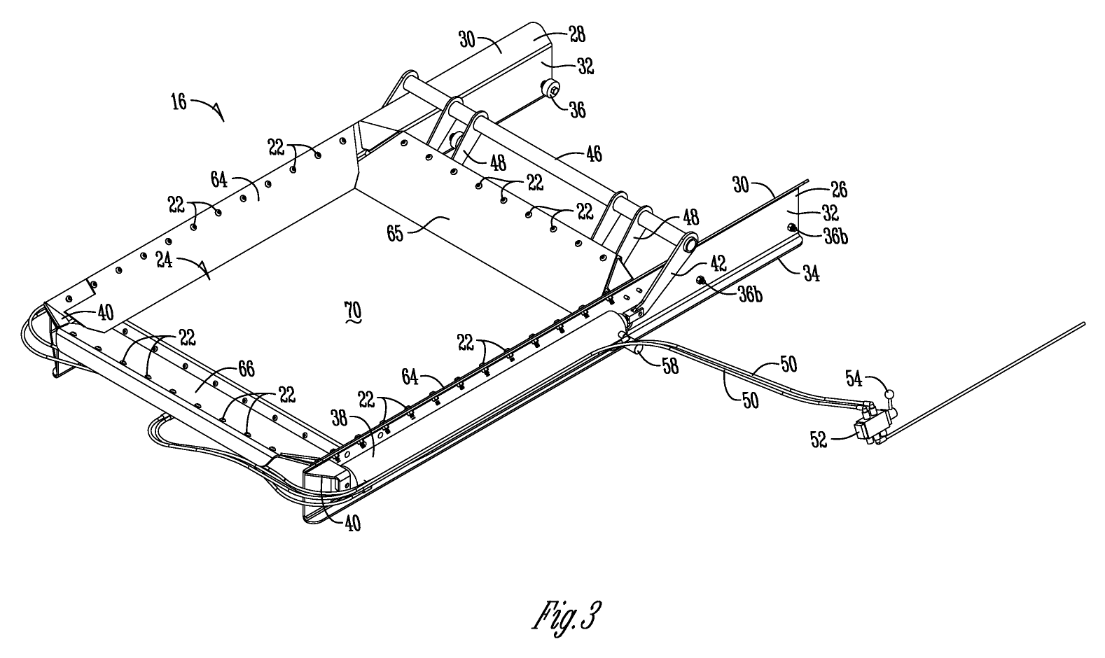

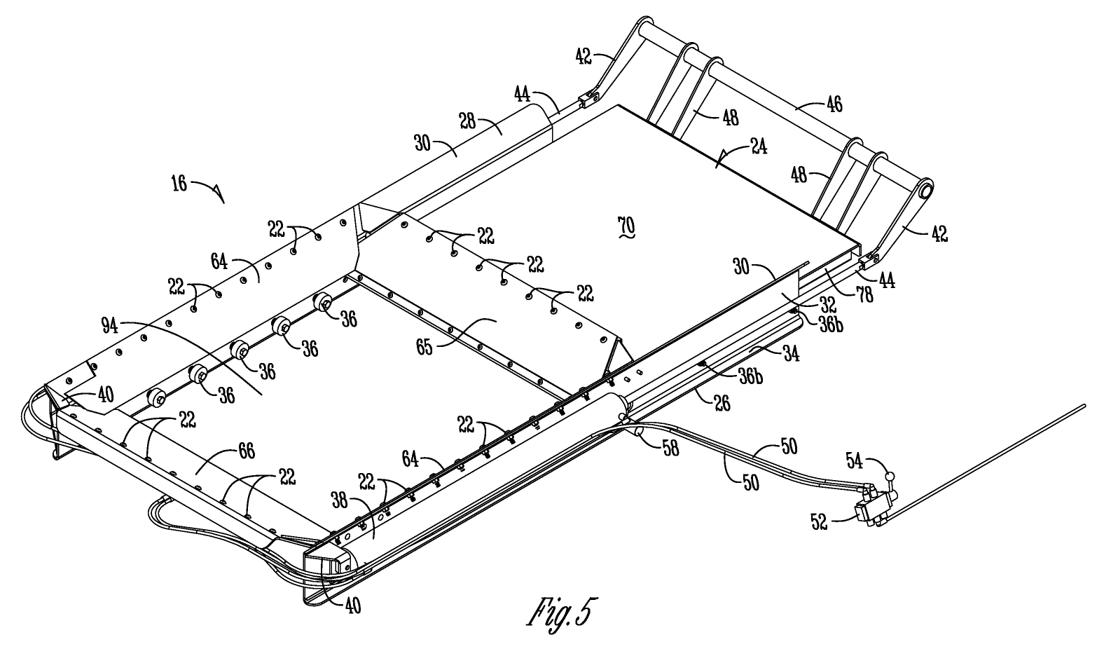

FIGS. 3-7 show the hopper door opening and closing apparatus 16 removed from the hopper trailer 10 in order to show some additional features of the apparatus 16. FIGS. 3 and 4 show the door 24 in a closed position. FIGS. 5-7 show the door 24 in an open position to permit flow through the discharge opening 94. Each of the side rails 26 and 28 is provided with a chute engaging flange 64 that mounts between the top portion 30 of the side rails 26 and 28. When mounted in place, the chute engaging flanges 64 are located between the side rails 26 ad 28 and the chute 14 (see FIG. 2) to extend downwardly from the chute 14 to provide a close fit with door 24 in order to prevent flow of grain, or other material through the opening 94. A rear transverse chute engaging flange 65 is mounted between the rails 26 and 28 and has a sloped face to match the contour of the lower portion of the hopper chute 14 (see FIG. 2) to which the flange 65 is to be mounted. The rear transverse chute engaging flange 65 (see FIGS. 5 & 6) also has a close fit at its bottom edge with the door 24. A front transverse chute engaging flange 66 is mounted between the rails 26 and 28 and has a sloped face to match the contour of the lower portion of the hopper chute 14. The front transverse chute engaging flange 65 extends farther downward than flanges 64 and 65 in order to provide a surface on which the leading edge of the door 24 can rest against to seal the discharge opening 94.

Additional details regarding the structure of the door 24 can be seen in FIG. 7, which is an underside view of the hopper door opening and closing apparatus 16 with the door 24 adjusted into an open position. The primary structural component of the door 24 is a door plate 70 that is a generally planar rigid sheet. On its bottom surface, the door plate 70 is provided with three rigid braces 72, which may be attached by welding or other known mechanisms to provide support and stiffness to the door 24. A door stop 74, which may be a flange, or other protrusion, is attached to the bottom surface of the door plate 70 to limit the movement of the door 24 by interfering with spindle 58 to prevent the door from being opened too far, and by engaging flange 66 to prevent the door from moving too far past the closed position. The bottom surface of the door plates 70 is also provided with racks 76 that align and correspond with pinions 60. A pair of bearing tracks 78 are provided on the bottom surface of door plate 70 to provide a bearing surface for the door on the rollers 36. Preferably, the bearing tracks 78 will be formed from hard, durable, low-friction material. The leading edge of the door plate 70 may be provided with a low-friction bumper 80 that will engage and ride on the lower portion of the transverse flange 66, when the door 24 is moved into the closed position of FIGS. 3 and 4.

The preferred material for most of the components of the hopper door opening and closing apparatus 16 is steel. For example, the side rails 26 and 28, the braces 40, the link members 42, the flanges 64, 65 and 66, the support 56, the link members 42, and the connection flanges 48 can all be formed from steel sheets that have been cut and bent to the desired size and shape. These components can then be painted or powder coated or otherwise treated to provide a nice esthetic appearance, and to prevent or retard corrosion. Preferably, the components may be painted to match the color of the trailer 10, or the hopper chutes 14. Nevertheless, those of ordinary skill in the art will be aware of other materials that are suitable for forming the various components of the invention, such as aluminum or stainless steel or other materials.

In the embodiment shown in the Figures, the base ends of the pneumatic cylinders 38 and 39 are pinned within corresponding braces 40, as noted above. The braces 40 are attached to the outer faces of the side rails 26 and 28 by welding, or other mechanisms. Those of ordinary skill in the art will be aware of numerous options for operably attaching the base ends of the pneumatic cylinders 38 and 39 to the rails 26 and 28. Additionally, those of skill in the art will be aware that it may be possible to attach the base end of the cylinders 38 and 39 to other portions of the door opening and closing apparatus 16, or to the hopper chute 14 or to the portion of the trailer 10. However the location of the cylinders 38 and 39 on the outside faces of the rails 26 and 28 is advantageous as it provides for a convenient and simple location for mounting the cylinders 38 and 39, and protects the cylinders 38 and 39 from the flow of grain through the discharge opening.

The disclosed mechanism for connecting the cylinders 38 and 39 to the door 24 provides support for the rod end of the cylinders 38 and 39 without any additional bracing or structure provided on the rails 26 and 28. The weight of the rod end of the cylinders 38 and 39 is supported by the door 24. This is accomplished through the use of the connection flanges 48 as shown in Figures. The connection flanges 48 have a generally unshaped configuration with a flat bottom portion that bolts or welds to the door 24, as best seen in FIG. 2. A pair of arms extend generally upwardly and longitudinally away from the door 24 and are provided with openings near their distal ends for receiving rod 46. Link members 42 are also each provided with an aperture for receiving bar 46 and are rigidly affixed to the bar 46, preferably by welding, to maintain a constant orientation of the link members 42 with respect to the bar 46. The piston rods 44 are pinned to the lower ends of links 42 to connect the piston rods to the door 24, and to support the rod end of the pneumatic cylinders 38 and 39.

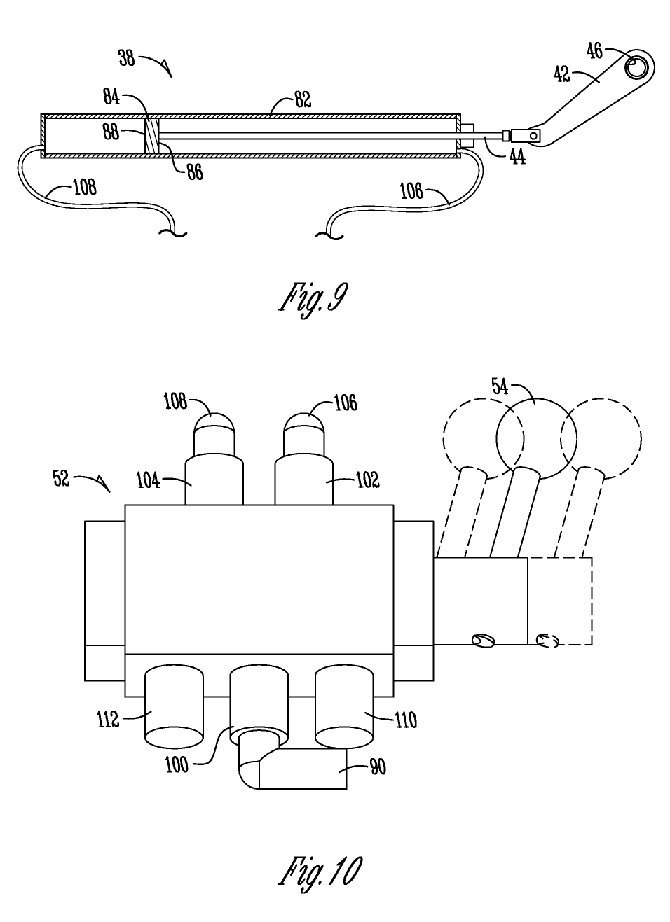

FIG. 9 is a cross sectional view of pneumatic cylinder 38. It should be appreciated that cylinder 39 would have the same appearance. The pneumatic cylinder 38 includes a cylinder case 82 that is sealed, except for input from air lines 106 and 108. A piston 84 that has a first side 86 and a second side 88 is provided for reciprocal movement within the case 82. The piston rod 44 extends from the first side 86 of the piston 84. The piston rod 44 is pinned to link member 42 that is operably connected to the door 24 as shown in previous figures. Air lines 106 and 108 can be used to create a pressure difference across the piston 84 in order to apply a force towards the first 86 or second 88 sides of the piston 84 as desired to thereby apply the same force to the door 24 through rod 44 and link member 42.

The amount of force generated by the cylinders 38 and 39 can be varied by increasing or decreasing the diameter of the cylinder case. The input pressure from most trailer air supplies will be in the range of about 110-120 psi. According to one embodiment a cylinder having an inner diameter of about two inches and a stroke length of about 28.5 inches has been found to be effective. A commercially available cylinder with the brand name Norgren and the identification RP200X28.5—DAPSS may be suitable for the purpose. Those of skill in the art will be able choose appropriately sized and configured cylinders depending on the requirements of the situation.

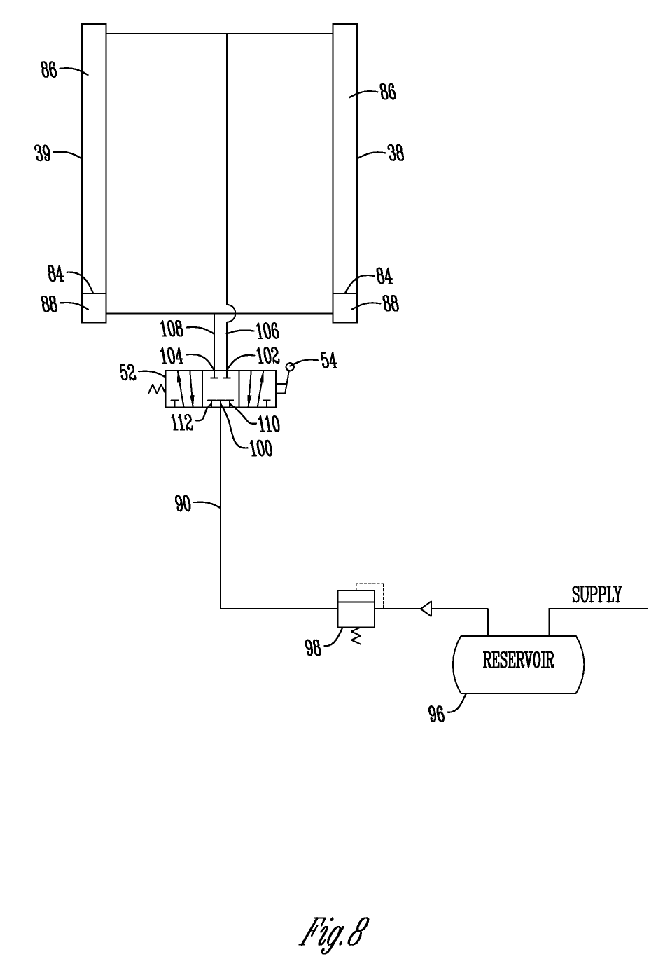

FIG. 8 is a schematic of the pneumatic components shown in the drawings. Pressurized air is provided from a supply, typically a compressor or similar mechanism within the truck or other towing vehicle. The pressurized air may be stored within a reservoir 96 or storage tank that is used to supply pressurized air to the trailer's air brakes and air suspension systems. A lockout valve 98 is provided in-line between the reservoir 96 and the control valve 52 such that the door opening and closing apparatus 16 cannot deplete air pressure in the reservoir 96 below a minimum amount desired to assure that the air brakes will function and have some margin for safety. The control valve is a four-way three-position closed-center valve. The control valve 52 is spring-biased to the center position, and is adjustable with handle 54 to a left or right position. The control valve 52 includes a supply input 100, a first-side output 102 and a second-side output 104. The supply input 100 is connected to air line 90 that provides pressurized air from the supply. First-side output 102 is connected to line 106 that pneumatically connects the output 102 with the first and second cylinders 38 and 39 on first sides 86 of the pistons 84. The second-side output 104 is connected to air line 108 that pneumatically connects the output 104 with the cylinders 38 and 39 on second sides 88 of the pistons 84. Those of skill in the art will understand that rather than using a manually adjustable valve that include handle 54, a solenoid-type valve could be used. The solenoid version would permit remote activation of the door opening apparatus 16, such as for example by a RF transmitter. It should also be understood that a solenoid version would require attachment to an electrical source, such as a 12V battery.

When the control valve 52 is in the neutral center position, the input 100 and the outputs 102 and 104 are sealed to prevent any air flow. Therefore, the pressure on both sides 86 and 88 of the pistons 84 is static and the pistons are maintained in position. By maintaining pressure within the lines 106 and 108, movement of the pistons 84, and hence the door 24 is resisted.

The control valve 52 is also provided with a first-side exhaust port 110 and a second-side exhaust port 112. Preferably these exhaust ports 110 and 112 will be restricted to slowly release pressure.

The valve 52 can be adjusted to a first configuration that opens the door 24 by moving the handle right (as seen in FIG. 8) to connect the first-side output 102 with first side exhaust port 110 and second-side output 104 with the input 100. In this first configuration, pressurized air is provided to the second side 88 of the piston 84, and air is exhausted or vented from the first side 86. The pressure difference between the sides 86 and 88 will urge the piston 84 to move towards the lower pressured first side 86, to apply an opening force on the door 24.

The valve 52 can be adjusted to a second configuration that closes the door 24 by moving the handle left (as seen in FIG. 8) to connect the second-side output 104 with second-side exhaust port 112 and the first-side output 102 with input 100. In this second configuration, pressurized air is provided on the first side 86 of the piston 84, and air is exhausted or vented from the second side 88. The pressure difference between the sides 86 and 88 will urge the piston 84 to move towards the lower pressured second side 88, to apply a closing force on the door 24.

FIG. 10 shows a control valve 52 according to the embodiment shown in the schematic of FIG. 8. The control valve 52 has a center neutral position that is shown in solid lines. It is normally biased to this position by an internal spring. The control valve 52 may be adjusted to provide an opening force to the door 24 by moving handle 54 to the right (as shown in FIG. 10). This may require pulling the handle 54 in order to disengage it from a catch that holds it in the neutral position. As described above, movement of the handle 54 to the right position (indicated in broken lines in FIG. 10) will connect the pressurized air from line 90 with the second-side air line 108 to provide pressurized air on the second side 88 of the piston 84, while simultaneously connecting the first-side air line 106 with exhaust port 110 to vent air and thereby reduce pressure on the first side 86 of the piston 84. Similarly, adjustment of the handle 54 to the left position (indicated in broken lines in FIG. 10) will provide a closing force on the door. Adjusting the handle to the closing position will connect the pressurized air from line 90 with the first-side air line 106 to provide pressurized air on the first side 86 of the piston 84, while simultaneously connecting the second-side air line 108 with exhaust port 112 to vent air and thereby reduce pressure on the second side 88 of the piston 84. A commercially available valve with the brand name Versa Valve and model number CBL 4303 is an example of such a valve.

The apparatus 16 permits smooth opening and closing of the door 24 without jerking or lurching often associated with pneumatic systems. Outputs 102 and 104 are sealed tight when the valve 52 is in the neutral position. Therefore, when the system is in the steady state with the valve 52 in its neutral position, pressure is maintained on both sides 86 and 88 of the piston 84. By maintaining the pressure on both sides of the piston 84, it is assured that upon actuation of the valve 52 movement of the piston 84 is provided against resistance on its lower pressure side. Therefore, the initial movement will occur smoothly, and the door will be not slammed open or shut and will not jump or lurch upon initiation.

The apparatus 16 also provides for accurate control of the movement and positioning of the door 24. In this regard, restricting the exhaust ports 110 and 112 helps in providing a smooth controlled movement of the door 24. Because the pressure difference across the piston 84 will never be too large, movement of the piston 84, and hence the door 24, will be relatively slow and controlled. Therefore, nearly instantaneously with the movement of the control valve 52 back to the neutral position, the door 24 will stop and maintain its position, without significant bounce or damping motion. The relatively slow movement of the door means there is not significant momentum, and the small pressure difference across the piston 84 permits quick equalization of the pressure. Therefore, the flow rate of material through the discharge opening can be accurately controlled with the present apparatus 16.

Presently preferred embodiments of the present invention have been described with a degree of particularity. The previous description is of preferred examples for implementing the invention, and the scope of the invention should not necessarily be limited by this description. The scope of the present invention is defined by the scope of the following claims.

We claim:

1. A hopper door assembly comprising:
a first rail for mounting to a discharge chute that has a downwardly disposed opening, the first rail having an inner face that generally faces toward the chute and an outer face that generally faces away from the chute;
a second rail for mounting to the discharge chute opposite and parallel to the first rail, the second rail having an inner face that generally faces toward the chute and an outer face that generally faces away from the chute;
a slidable door movable between a closed position to cover the discharge chute opening and an open position to permit flow through the discharge chute opening; and
a first pneumatic cylinder connected to the slidable door to selectively urge the door towards the open and closed positions.

2. The hopper door assembly of claim 1, wherein the first cylinder is mounted outside the outer face of the first rail, and further comprising a second pneumatic cylinder mounted outside the outer face of the second rail and operably connected to the slidable door to selective move the door between the open and closed positions.

3. The hopper door assembly according to claim 1, wherein the first and second pneumatic cylinders are mounted on the outer faces of the rails.

4. The hopper door assembly of claim 3, wherein a portion of the weight of the first and second pneumatic cylinders is supported by the door.

5. The hopper door assembly of claim 3, further comprising:
a bar;
a first link connecting the first pneumatic cylinder to the bar;
a second link connecting the second pneumatic cylinder to the bar; and
a bracket connecting the bar to the door to thereby operably connect the pneumatic cylinders with the door.

6. The hopper door assembly of claim 1, wherein the first pneumatic cylinder has a piston within a cylinder case, the hopper door assembly further comprising:
a connection to a supply of pressurized air;
a valve in pneumatic connection between the connection to the supply of pressurized air and the first pneumatic cylinder case, the valve having a first configuration to simultaneously exhaust air from first pneumatic cylinder case on a first side of the piston and supply pressurized air from the supply on a second side of the piston to urge the piston in the direction of the first side to open the door, the valve having a second configuration to simultaneously supply pressurized air from the supply on the first side of the piston and exhaust air on the second side of the piston to urge the piston towards the second side and thereby close the door, and the valve having a third configuration that prevents air from flowing into and out of the cylinder case on both sides of the piston to maintain the door in a steady state; and
a control for selectively moving the valve between the first, second, and third configurations.

7. The hopper door assembly of claim 6, wherein the valve is self-urging towards the third configuration and requires adjustment of the control to be adjusted into the first and second configurations.

8. The hopper door assembly of claim 7, wherein the valve is a self-centering lockout valve.

9. The hopper door assembly of claim 6, wherein the valve has exhaust ports for exhausting air from the cylinder case, and further wherein the exhaust ports have restrictions to limit the flow of air through the exhaust ports.

10. A hopper trailer for hauling granular material and for discharging the granular material through a downwardly disposed hopper; the hopper trailer comprising:
a trailer body including a storage compartment;
a downwardly disposed discharge opening in the hopper in flowable communication with the storage compartment;
a slidable door movable between a closed position to cover the discharge opening and an open position to permit flow of granular material from the storage compartment through the discharge opening;
a connection to a supply of pressurized air;
a pneumatic cylinder in operable connection with the hopper door; and
a control valve in pneumatic connection between the pneumatic cylinder and the supply of pressurized air for selectively activating the pneumatic cylinder to move the hopper door between the open and the closed positions.

11. The hopper trailer according to claim 10, wherein the pneumatic cylinder comprises a piston within a cylinder case, the piston having a first side and a second side, and further wherein the control valve is adapted to maintain elevated pressures on both sides of the piston within the cylinder case as the cylinder is activated to move the hopper door between the open and closed positions.

12. The hopper trailer according to claim 11, wherein the control valve is adapted to maintain an elevated pressure on both sides of the piston within the cylinder case when the cylinder is in a steady state ready to be activated.

13. The hopper trailer according to claim 10, wherein the control valve has a first position to simultaneously exhaust air on a first side of the piston and supply pressurized air from the supply on a second side of the piston to urge the piston in the direction of the first side to open the door, the valve having a second position to simultaneously supply pressurized air from the supply on the first side of the piston and exhaust air on the second side of the piston to urge the piston towards the second side and thereby close the door, and the valve having a third position that prevents air from flowing into and out of the cylinder on both sides of the piston to maintain the door in a steady state.

14. The hopper trailer of claim 10, further comprising:
a first rail for mounted to the hopper, the first rail having an inner face that generally faces toward the hopper and an outer face that generally faces away from the hopper;
a second rail for mounting to the hopper parallel to the first rail, the second rail having an inner face that generally faces toward the hopper and an outer face that generally faces away from the hopper; and
wherein the slidable door is mounted between and supported by the rails, and the pneumatic cylinder is mounted to the first rail such that it is protected from the flow of granular material through the hopper.

15. The hopper trailer of claim 14, wherein the pneumatic cylinder is mounted at one end to the first rail and an another end to the door, such that the door supports a portion of the weight of the cylinder.

16. The hopper door assembly of claim 15, further comprising:
a second pneumatic cylinder mounted to the second rail;
a bar;
a first link connecting the first pneumatic cylinder to the bar;
a second link connecting the second pneumatic cylinder to the bar; and
a bracket connecting the bar to the door to thereby operably connect the pneumatic cylinders with the door.

17. A door opening and closing mechanism for attachment to a hopper frame of the type that has a discharge opening and a door slidably connected to the hopper frame for movement between a closed position to substantially block the opening and an open position to permit flow of particulate through the opening, the door opening and closing mechanism comprising:
a pneumatic cylinder and piston operably connected to the door and the frame to selectively move the door between the open and closed positions;
a connection to a supply of pressurized air;
a valve in line between the connection and the cylinder, the valve having a first position to simultaneously vent air on a first side of the piston and supply pressurized air from the supply on a second side of the piston to urge the piston in the direction of the first side to open the door, the valve having a second position to simultaneously supply pressurized air from the supply on the first side of the piston and vent air on the second side of the piston to urge the piston towards the second side and thereby close the door, and the valve having a third position that prevents air from flowing into and out of the cylinder on both sides of the piston to maintain the door in a steady state; and
a control for selectively moving the valve between the first, second, and third positions.

18. The door opening mechanism of claim 17 wherein when the valve is in the third position, it maintains an elevated pressure on both sides of the piston.

19. The door opening mechanism of claim 17, wherein the valve is self-urging towards the third position and requires adjustment of the control to be adjusted into the first and second configurations.
